(19) United States
(12) Patent Application Publication
(10) Pub. No.: US 2006/0094822 A1
(43) Pub. Date: May 4, 2006

(54) Method for reducing stringiness of a resinous composition during hot plate welding

(75) Inventors: Satish Kumar Gaggar, Parkersburg, WV (US); Shripathy Vilasagar, Parkersburg, WV (US)

Correspondence Address: Henry H. Gibson;GE Plastics, One Plastics Avenue, Pittsfield, MA, 01201, US

(73) Assignee: General Electric Company

(21) Appl. No.: 10/981,121

(22) Filed: Nov. 4, 2004

(51) Int. Cl. C08L 77/00

(52) U.S. Cl. 525/178

(57) ABSTRACT

Disclosed is a method for reducing stringiness during hot plate welding of an article comprising at least one rubber modified thermoplastic resin, which comprises the step of including an effective amount of a polyamide in the composition of the article to be welded; wherein said resin comprises a discontinuous elastomeric phase dispersed in a rigid thermoplastic phase, and wherein at least a portion of the rigid thermoplastic phase is grafted to the elastomeric phase. The method also results in improved cycle time for preparation of the final article. Final articles made by the said method are also disclosed.

### BACKGROUND OF THE INVENTION

The present invention relates to a method for reducing or eliminating stringiness in a resinous composition during hot plate welding. The present invention also relates to the final article produced by said method.

Hot plate welding is a well-known method for bonding two articles together, at least one of which articles comprises a resinous composition. Typically, hot plate welding comprises pressing a hot plate or heated surface against a first article, for example a molded article, comprising a solid resinous composition, thereby melting a portion of the surface of said article, and then adhering the melted portion to a second article, typically under pressure, to form a final article. Hot plate welding has the advantage of providing environmental protection because the method does not require sealing by an adhesive and does not use solvents or volatile organic compounds (VOC's). In the hot plate welding method, however, when the surface of the above-mentioned resinous composition is melted by a hot plate and then the hot plate is separated from the melted resin, the melted resin is sometimes drawn out from the surface in the form of strings (hereinafter referred to as “stringiness”). Such strings stick to the surface of the molded or formed product causing inferior appearance, increasing cycle time in the welding process, and reducing adhesion between the two articles. Past efforts for reducing stringiness during the hot plate welding process have relied on the use of specific resin combinations as in U.S. Pat. No. 6,270,615 and in published Japanese patent application 10-298419, or on the use of specific additives in resinous compositions, such as the addition of an antistatic agent as in U.S. Pat. No. 6,450,675 or the addition of a fluoro resin as in published Japanese patent application 09-012902. However, use of specific additives and resin combinations is not generally applicable to all types of resinous compositions. There remains a need for a more general method for reducing or eliminating stringiness during hot plate welding of articles comprising resinous compositions. There also remains a need for a more general method for reducing cycle time which is adversely affected by stringiness during hot plate welding of articles comprising resinous compositions.

### BRIEF DESCRIPTION OF THE INVENTION

The present inventors have discovered a method for reducing stringiness and reducing cycle time in the hot plate welding process. In one embodiment the present invention comprises a method for reducing stringiness during hot plate welding of an article comprising at least one rubber modified thermoplastic resin, which comprises the step of including an effective amount of a polyamide in the composition of the article to be welded; wherein said resin comprises a discontinuous elastomeric phase dispersed in a rigid thermoplastic phase, and wherein at least a portion of the rigid thermoplastic phase is grafted to the elastomeric phase. In another embodiment the present invention comprises a method for reducing stringiness during hot plate welding of an article comprising at least one rubber modified thermoplastic resin, which comprises the steps of (a) providing a composition comprising acrylonitrile-styrene-acrylate resin, acrylate-modified acrylonitrile-styrene-acrylate resin, methyl methacrylate-modified acrylonitrile-styrene-acrylate resin, acrylonitrile-butadiene-styrene resin; acrylonitrile-(ethylene-propylene-based rubber)-styrene resin; styrene-acrylonitrile grafted polydimethylsiloxane rubber resin; methyl methacrylate-butadiene-styrene resin, methyl methacrylate-acrylonitrile-butadiene-styrene resin; rubber modified acrylic resin; or rubber modified poly(methyl methacylate); (b) adding to the composition either polyamide-6 or polyamide-66 in an amount in a range of between about 1 wt. % and about 15 wt. %, based on the total weight of resinous components in the composition; (c) providing a first formed article comprising the composition from step (b); (d) contacting a hot plate against a surface of the formed article, thereby melting at least a portion of the surface of said article; (e) removing the hot plate from said surface; and then (f) adhering the melted portion to a second article to form a final article. Various other features, aspects, and advantages of the present invention will become more apparent with reference to the following description and appended claims.

### DETAILED DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. The terminology “monoethylenically unsaturated” means having a single site of ethylenic unsaturation per molecule. The terminology “polyethylenically unsaturated” means having two or more sites of ethylenic unsaturation per molecule. The term “acrylic polymers” means polymers comprising structural units derived from at least one (C₁-C₁₂)alkyl(meth)acrylate monomer. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. Unless otherwise specified, normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl or aryl. Some illustrative, non-limiting examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some particular illustrative, non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals comprise those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals comprising from 6 to 20 ring carbon atoms. Some illustrative non-limiting examples of aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative, non-limiting examples of aryl radicals comprise substituted or unsubstituted phenyl, biphenyl, tolyl, naphthyl and binaphthyl.

The details of the hot plate welding process are well known to those skilled in the art. In the present context the term “hot plate” comprises any heated surface for contact with the article to be welded. The temperature range for the hot plate and the time of contact with any article to be welded are those which are effective to effect welding of the articles which comprise the final article. In various embodiments the temperature and time of contact will depend upon the specific type of resinous composition comprising the article contacted with the hot plate, and may be readily determined without undue experimentation. In some specific embodiments the temperature of the hot plate may be in a range of between about 250° C. and about 500° C. In one optional embodiment at least that surface of the article to be subsequently contacted with the hot plate, or at least that portion of said surface to be subsequently contacted with the hot plate is contacted with water before contact with the hot plate. In another optional embodiment only that surface to be subsequently contacted with the hot plate, or only that portion of said surface to be subsequently contacted with the hot plate is contacted with water before contact with the hot plate. In some particular embodiments a method of the present invention may comprises the steps of (a) providing a composition comprising a rubber modified thermoplastic resin; (b) adding to the composition a polyamide; (c) providing a first formed article comprising the composition from step (b); (d) contacting a hot plate against a surface of the formed article, thereby melting at least a portion of the surface of said article; (e) removing the hot plate from said surface; and then (f) adhering the melted portion to a second article to form a final article. In other particular embodiments a method of the present invention may comprises the steps of (a) providing a composition comprising acrylonitrile-styrene-acrylate resin, acrylate-modified acrylonitrile-styrene-acrylate resin, methyl methacrylate-modified acrylonitrile-styrene-acrylate resin, acrylonitrile-butadiene-styrene resin; rubber modified acrylic resin; or rubber modified poly(methyl methacylate); (b) adding to the composition either polyamide-6 or polyamide-66 in an amount in a range of between about 1 wt. % and about 15 wt. %, based on the total weight of resinous components in the composition; (c) providing a first formed article comprising the composition from step (b); (d) contacting a hot plate against a surface of the formed article, thereby melting at least a portion of the surface of said article; (e) removing the hot plate from said surface; and then (f) adhering the melted portion to a second article to form a final article. Said second article may optionally comprise a resinous composition. The contacted surface of said second article may optionally be melted before contact with said first article. If melted, the contacted surface of said second article may optionally have been previously contacted with water.

In some embodiments resinous compositions suitable for use in the method of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise poly(butadiene) rubber, dimethyl siloxane/acrylate rubber, or silicone/acrylate composite rubber, wherein illustrative examples of acrylate comprise butyl, iso-octyl, 2-ethylhexyl and the like; polyolefin rubbers such as ethylene-propylene rubber or ethylene-propylene-diene (EPDM) rubber; or silicone rubber polymers such as polydimethyl siloxane rubber. The rubber substrate typically has a glass transition temperature, Tg, in one embodiment less than or equal to 25° C., in another embodiment below about 0° C., in another embodiment below about minus 10° C., in another embodiment below about minus 20° C., in another embodiment below about minus 30° C., in another embodiment below about minus 50° C., in still another embodiment below about minus 80° C., and in yet another embodiment below about minus 100° C. As referred to herein, the Tg of a polymer is the T value of polymer as measured by differential scanning calorimetry (DSC; heating rate 20° C./minute, with the Tg value being determined at the inflection point).

In one embodiment the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof; monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

There is no particular limitation on the particle size distribution of the rubber substrate (sometimes referred to hereinafter as initial rubber substrate to distinguish it from the rubber substrate following grafting). In some embodiments the initial rubber substrate may possess a broad particle size distribution with particles ranging in size from about 50 nanometers (nm) to about 1000 nm. In some other embodiments the initial rubber substrate may possess a broad particle size distribution with particles ranging in size from about 80 nm to about 500 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 1000 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises particles which are a mixture of particle sizes with two mean particle size distributions each in a range of between about 80 nm and about 750 nm. In another particular embodiment the surface aesthetics of molded parts are improved when a mixture of an initial rubber substrate with mean particle size of about 100 nm and an initial rubber substrate with mean particle size of about 500 nm is employed in a ratio in a range of between about 1:3 and about 5:1. In still another particular embodiment a mixture of an initial rubber substrate with mean particle size of about 100 nm and an initial rubber substrate with mean particle size of about 500 nm is employed in a ratio of about 3:1. In some embodiments the particle size distribution refers to weight average values.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers. Illustrative examples of copolymerizable monomers comprise copolymerizable (meth)acrylate monomers.

In one embodiment the rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin. Two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be formed solely by polymerization carried out in the presence of rubber substrate, or by addition of one or more separately synthesized rigid thermoplastic polymers to the rubber modified thermoplastic resin comprising the composition, or by a combination of both processes. In some embodiments the separately synthesized rigid thermoplastic polymer comprises structural units essentially identical to those of the rigid thermoplastic phase comprising the rubber modified thermoplastic resin. In some particular embodiments separately synthesized rigid thermoplastic polymer comprises structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate. When at least a portion of separately synthesized rigid thermoplastic polymer is added to the rubber modified thermoplastic resin, then the amount of said separately synthesized rigid thermoplastic polymer added is in one embodiment in a range of between about 5 wt. % and about 90 wt. %, in another embodiment in a range of between about 5 wt. % and about 80 wt. %, in another embodiment in a range of between about 10 wt. % and about 70 wt. %, in another embodiment in a range of between about 15 wt. % and about 65 wt. %, and in still another embodiment in a range of between about 20 wt. % and about 65 wt. %, based on the weight of resinous components in the composition. Two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. No. 3,944,631; and in U.S. patent application Ser. No. 08/962,458, filed Oct. 31, 1997. The unsaturated sites in the rubber phase are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in commonly assigned U.S. patent application Ser. No. 10/748,394, filed Dec. 30, 2003.

In a preferred embodiment the rubber modified thermoplastic resin is an ASA (acrylonitrile-styrene-acrylate) resin such as that manufactured and sold by General Electric Company under the trademark GELOY®. In one embodiment a suitable ASA resin is an acrylate-modified acrylonitrile-styrene-acrylate resin. ASA resins include, for example, those disclosed in U.S. Pat. No. 3,711,575. ASA resins also comprise those described in commonly assigned U.S. Pat. Nos. 4,731,414 and 4,831,079. In some embodiments of the invention where an acrylate-modified ASA is used, the ASA component further comprises structural units derived from monomers selected from the group consisting of C₁ to C₁₂ alkyl- and aryl-(meth)acrylate as part of either the rigid phase, the rubber phase, or both. Such copolymers are sometimes referred to as acrylate-modified acrylonitrile-styrene-acrylate resins, or acrylate-modified ASA resins. A preferred monomer is methyl methacrylate and the resulting modified polymer is sometimes referred to hereinafter as “MMA-ASA”. Other rubber modified thermoplastic resins suitable for use in the method of the present invention comprise acrylonitrile-butadiene-styrene resins (ABS); acrylonitrile-(ethylene-propylene-based rubber)-styrene resins (AES); styrene-acrylonitrile grafted polydimethylsiloxane rubber resins; methyl methacrylate-butadiene-styrene resin (MBS), methyl methacrylate-acrylonitrile-butadiene-styrene resin (MABS), rubber modified acrylic resins; and rubber modified poly(methyl methacrylate) (PMMA). Suitable resins may comprise recycled or reground thermoplastic resin or rubber modified thermoplastic resin.

Polyamides suitable for use in compositions of the present invention may be made by any known method. Suitable polyamides include those of the type prepared by the polymerization of (i) a monoamino-monocarboxylic acid or a lactam thereof having at least 2 carbon atoms between the amino and carboxylic acid group; (ii) of substantially equimolar proportions of a diamine which contains at least 2 carbon atoms between the amino groups and a dicarboxylic acid; or (iii) of a monoaminocarboxylic acid or a lactam thereof as defined above together with substantially equimolar proportions of a diamine and a dicarboxylic acid. The dicarboxylic acid may be used in the form of a functional derivative thereof, for example, an ester or acid chloride.

Examples of the aforementioned monoamino-monocarboxylic acids or lactams thereof which are useful in preparing the polyamides include those compounds containing from 2 to 16 carbon atoms between the amino and carboxylic acid groups, said carbon atoms forming a ring with the —CO—NH— group in the case of a lactam. As particular examples of aminocarboxylic acids and lactams there may be mentioned 6-aminocaproic acid, butyrolactam, pivalolactam, ε-caprolactam, capryllactam, enantholactam, undecanolactam, dodecanolactam and 3- and 4-aminobenzoic acids.

Diamines suitable for use in the preparation of the polyamides include the straight chain and branched chain alkyl, aryl and alkaryl diamines. Illustrative diamines are trimethylenediamine, tetramethylenediamine, pentamethylenediamine, octamethylenediamine, hexamethylenediamine (which is often preferred), trimethylhexamethylenediamine, m-phenylenediamine, and m-xylylenediamine.

Suitable dicarboxylic acids include those which contain an aliphatic or aromatic group containing at least 2 carbon atoms separating the carboxy groups. The aliphatic acids are often preferred; they include, but are not limited to, succinic acid, glutaric acid, adipic acid, pimelic acid, suberic acid, sebacic acid, undecanedioic acid, and octadecanedioic acid.

For most purposes, the preferred polyamides by reason of their availability and particular suitability are poly(hexamethylene adipamide), hereinafter designated “polyamide-66”, and poly(caprolactam), hereinafter designated “polyamide-6”. Mixtures of polyamides are also suitable for use in the compositions of the invention. In particular mixtures of polyamides with different amine end group concentrations are suitable, such as mixtures of two polyamide-6 grades or mixtures of two polyamide-66 grades or mixtures of polyamide-6 and polyamide-66 with different amine end-group concentrations. Moreover, the amine to acid end-group ratio of the polyamide resin may also be varied as well as the relative viscosity of the polyamide contained within the resin composition. Typically the molecular weight of the polyamide or the respective molecular weights of a mixture of polyamides may be chosen to provide any desired balance of physical properties, such as flow and impact properties, and may be readily determined by those skilled in the art without undue experimentation.

The amount of polyamide present in compositions of the invention is an amount effective to provide reduction or elimination of stringiness in molded parts of said compositions subjected to hot plate welding processes. The amount of polyamide present in said compositions may be in one particular embodiment in a range of between about 1 wt. % and about 15 wt. %, in another particular embodiment in a range of between about 2 wt. % and about 12 wt. %, and in still another particular embodiment in a range of between about 4 wt. % and about 11 wt. %, based on the total weight of resinous components in the composition. In still other particular embodiments the amount of polyamide present in said compositions is less than about 10 wt. %, based on the total weight of resinous components in the composition.

Polyamide is typically present in the composition of the first article of the final article prepared by hot plate welding. Optionally, polyamide may also be present in the composition of the second article of the final article prepared by hot plate welding.

In a preferred embodiment polyamide is only present in the composition of the first article of the final article prepared by hot plate welding. In one particular embodiment a first or bottom article comprises both polyamide and a rubber modified thermoplastic resin such as ASA, and a second or top article comprises an acrylic resin.

In addition to rubber modified thermoplastic resin and polyamide, the compositions of the invention may optionally comprise at least one of a polystyrene, a syndiotactic polystyrene, a styrene/acrylonitrile copolymer, an alpha-methylstyrene/acrylonitrile copolymer, an alpha-methylstyrene/styrene/acrylonitrile copolymer, a styrene/acrylonitrile/methyl methacrylate copolymer, an alpha-methylstyrene/acrylonitrile/methyl methacrylate copolymer, an alpha-methylstyrene/styrene/acrylonitrile/methyl methacrylate copolymer, a styrene/methyl methacrylate copolymer, poly(vinyl chloride); a polycarbonate; a bisphenol A polycarbonate; an acrylic polymer; poly(methyl methacrylate); a polyester; a poly(alkylene terephthalate); a poly(alkylene naphthalate); poly(ethylene terephthalate); poly(butylene terephthalate); poly(trimethylene terephthalate); poly(ethylene naphthalate); poly(butylene naphthalate); poly(cyclohexanedimethanol terephthalate); poly(cyclohexanedimethanol-co-ethylene terephthalate); poly(1,4-cyclohexane-dimethyl-1,4-cyclohexanedicarboxylate); a polyarylate; a polyarylate with structural units derived from resorcinol and a mixture of iso- and terephthalic acids; a polyestercarbonate; a polyestercarbonate with structural units derived from bisphenol A, carbonic acid and a mixture of iso- and terephthalic acids; a polyestercarbonate with structural units derived from resorcinol, carbonic acid and a mixture of iso- and terephthalic acids; a polyestercarbonate with structural units derived from bisphenol A, resorcinol, carbonic acid and a mixture of iso- and terephthalic acids; or mixtures of the foregoing resins.

Compositions of the invention may optionally comprise a compatibilizer for the polyamide and the rubber modified thermoplastic resin. Any known compatibilizer for polyamide and rubber modified thermoplastic resin may be used. In some embodiments a suitable compatibilizer comprises both rubber modified thermoplastic resin-compatible moieties and also chemical functionality, such as carboxylic acid and/or carboxylic anhydride which may react with amine functionality on polyamide to form copolymer. In other embodiments a suitable compatibilizer comprises both rubber modified thermoplastic resin-compatible moieties and also polyamide-compatible moieties, such as amide structural units. Illustrative examples of compatibilizers include, but are not limited to, copolymers comprising structural units derived from styrene in combination with at least one carboxylic acid monomer, carboxylic acid anhydride monomer, carboxylic acid amide monomer; epoxy monomer; or oxazoline monomer. Other illustrative examples of compatibilizers include, but are not limited to, styrene/maleic anhydride copolymer; styrene/acrylonitrile/maleic anhydride copolymer; styrene/acrylonitrile/acrylic acid copolymer; styrene/acrylonitrile/acrylamide copolymer; styrene/glycidyl methacrylate copolymer; styrene/acrylonitrile/glycidyl methacrylate copolymer; styrene/isopropenyl oxazoline copolymer; and styrene/acrylonitrile/isopropenyl oxazoline copolymer.

In some particular embodiments suitable compositions for use in the method of the invention comprise blends of at least one rubber modified thermoplastic resin in combination with at least one other thermoplastic resin. Illustrative examples of such blends comprise blends of ASA and polycarbonate (PC); blends of ABS and PC; blends of ABS and a polyester; blends of ABS and poly(butylene terephthalate); blends of ABS and an acrylic polymer; blends of ABS and PMMA; and blends comprising at least one of an ASA or an MMA-ASA in combination with at least one resin selected from the group consisting of styrene-acrylonitrile copolymer (SAN), alpha-methyl styrene-acrylonitrile copolymer (AM-SAN), styrene-acrylonitrile-methyl methacrylate copolymer (MMA-SAN), and combinations thereof. In other particular embodiments PC consists essentially of bisphenol A polycarbonate.

Compositions of the present invention may also optionally comprise additives known in the art including, but not limited to, fluoropolymers, polytetrafluoroethylene, silicone oil, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers and mixtures thereof.

The compositions useful in the method of the invention may be made by combining and intimately mixing the components of the composition under conditions suitable for the formation of a blend of the components. Illustrative examples of methods for combining and intimately mixing the components of the composition comprise melt mixing using, for example, a two-roll mill, a kneader, a Banbury mixer, a disc-pack processor, a single screw extruder or a co-rotating or counter-rotating twin-screw extruder; and, following melt mixing, then reducing the composition so formed to particulate form, for example by pelletizing or grinding the composition. Because of the availability of melt mixing equipment in commercial polymer processing facilities, melt processing procedures are generally preferred. When compositions are prepared by extrusion, they may be prepared by using a single extruder having multiple feed ports along its length to accommodate the addition of the various components at different points in the mixing process. In some embodiments it may also sometimes be advantageous to employ at least one vent port in each section between the feed ports to allow venting (either atmospheric or vacuum) of the melt. Those of ordinary skill in the art will be able to adjust blending times and temperatures, as well as component addition location and sequence, without undue additional experimentation.

Articles to be hot plate welded may be prepared by any method used to form thermoplastic compositions. In an illustrative, non-limiting embodiment articles to be hot plate welded are formed by injection molding.

The compositions of the present invention can be formed into useful final articles. Illustrative final articles comprise any of those known to be made using a hot plate welding process. Particular final articles comprise a lamp employed for vehicle use such as a headlamp, turn signal lamp, or tail light lamp, in which a lamp lens is joined to a lamp body comprising a resinous composition. Other examples of final articles comprise joined plastic pipe. fuel filters, fuel tanks, brake fluid tanks, radiator expansion tanks, water pumps, vacuum reservoirs, batteries, and the like.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples and comparative example MMA-ASA-1 is a copolymer comprising structural units derived from about 9 wt. % methyl methacrylate, about 32 wt. % styrene, about 15 wt. % acrylonitrile, and about 45 wt. % butyl acrylate, wherein the initial rubber particle size was about 110 nm. MMA-ASA-2 is a copolymer comprising structural units derived from about 9 wt. % methyl methacrylate, about 32 wt. % styrene, about 15 wt. % acrylonitrile, and about 45 wt. % butyl acrylate, wherein the initial rubber particle size was about 500 nm. AM-SAN is a copolymer comprising structural units derived from 70 wt. % alpha-methyl styrene and 30 wt. % acrylonitrile prepared by bulk polymerization. SAN is a copolymer comprising 72 wt. % styrene and 28 wt. % acrylonitrile with a weight average molecular weight (Mw) of about 100,000 made by a bulk polymerization process. Polyamide is a nylon-6 (ULTRAMID B3 available from BASF Corporation). HDT values in ° C. were determined according to ISO 179. Gloss was measured at an angle of 60 degrees according to standard protocols such as ASTM D 523 or DIN 67530 or ISO 2813. Viscosity values in units of pascal·seconds were determined at various shear rates using a Kayeness capillary rheometer under conditions of 260° C. melt temperature. The observed extent of the strings emanating from the surfaces test bars is recorded on a relative scale of 0-5 with 0 representing no stringiness observed and 5 representing heavy strings observed across the entire bar based on a comparison of the test parts at the time of the test. No significant stringing from the bar's surface indicates a scale value of about 0-1. This test is an empirical method and only relative comparisons can be made. The following examples and comparative examples illustrate the benefit of including a polyamide in resinous compositions of the invention in order to reduce or eliminate stringiness during hot plate welding. Cycle time between molding of the parts and hot plate welding is also decreased by including a polyamide in resinous compositions of the invention.

### EXAMPLES 1-4 AND COMPARATIVE EXAMPLE 1

Resinous compositions are prepared comprising the components shown in Table 1. In addition to the listed components each composition comprises 0.5 parts per hundred parts resin (phr) ethylene bis-stearamide (EBS). In addition the compositions typically comprise minor amounts of antioxidants, UV screeners, and lubricants which are not believed to affect stringiness. Molded test bars are prepared from each of the compositions. The molded test bars are individually brought into contact with a hot plate for 15 seconds at 0.55 megapascals and 288° C. Upon removal of the bar from the hot plate, the relative degree of stringiness from the bar's surface is observed. The value for relative degree of stringiness shown in the table represents the rounded average of observations for three test bars. The data in the table show that compositions for examples of the invention comprising polyamide show significantly reduced stringiness compared to the composition of the comparative example not comprising polyamide. Also the examples of the invention retain their HDT and surface gloss properties, while melt viscosity is not significantly increased with addition of polyamide.

TABLE 1

| Component | C. Ex. 1 | Ex. 1 | Ex. 2 | Ex. 3 | Ex. 4 |
|---|---|---|---|---|---|
| MMA-ASA-1 | 33 | 33 | 33 | 33 | 36.7 |
| MMA-ASA-2 | 12 | 12 | 12 | 12 | 13.3 |
| AM-SAN | 45 | 45 | 45 | 45 | 42.5 |
| SAN | 10 | 5 | 2.5 | — | — |
| polyamide | — | 5 | 7.5 | 10 | 7.5 |
| HDT, ° C. | 100.0 | 101.7 | 100.4 | 101.1 | 100.1 |
| Gloss, 60° | 95.6 | 95.8 | 95.7 | 95.5 | 95.1 |
| Melt viscosity, | 211 | 221 | 209 | 207 | 233 |
| Pa · s at | | | | | |
| 1000 sec.⁻¹ | | | | | |
| stringiness | 4 | 1 | 0 | 0 | 0 |

### EXAMPLE 5 AND COMPARATIVE EXAMPLE 2

Molded test bars are prepared from a composition comprising the components used in Examples 1-4 except that the mixture of MMA-ASA-1 and MMA-ASA-2 is replaced with a single type of MMA-ASA with a broad particle size distribution with mean particle sizes in a range of between about 80 nm and about 500 nm. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLES 6 AND COMPARATIVE EXAMPLE 3

Molded test bars are prepared from a composition comprising the components used in Examples 1-4 except that polyamide-6 is replaced with polyamide-66. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLES 7 AND COMPARATIVE EXAMPLE 4

Molded test bars are prepared from a composition comprising the components used in Example 5 except that polyamide-6 is replaced with polyamide-66. For a comparative example molded test bars are prepared comprising similar compositions but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLE 8 AND COMPARATIVE EXAMPLE 5

Molded test bars are prepared from a composition comprising the components of Examples 1-4 except that the mixture of MMA-ASA-1 and MMA-ASA-2 is replaced with ASA having a broad particle size distribution with mean particle sizes in a range of between about 80 nm and about 500 nm. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLE 9 AND COMPARATIVE EXAMPLE 6

Molded test bars are prepared from compositions comprising ASA and polyamide. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLE 10 AND COMPARATIVE EXAMPLE 7

Molded test bars are prepared from compositions comprising ABS and polyamide. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLE 11 AND COMPARATIVE EXAMPLE 8

Molded test bars are prepared from compositions comprising ABS-PC blend and polyamide. For a comparative example molded test bars are prepared comprising a similar composition but not comprising polyamide. Molded test bars of both the example of the invention and the comparative example are individually contacted with a hot plate. Upon removal of bars from the hot plate, less stringing is observed from the surface of the bar comprising the composition of the invention than is observed from the surface of the bar of the comparative example.

### EXAMPLE 12 AND COMPARATIVE EXAMPLE 9

Molded test bars are prepared from a composition comprising styrene-acrylonitrile-maleic anhydride copolymer and the components of Example 1. For a comparative example molded test bars are prepared comprising a similar composition but not comprising styrene-acrylonitrile-maleic anhydride copolymer. Molded test parts of both the example of the invention and the comparative example are individually contacted with a hot plate. Upon removal of bars from the hot plate, less stringing is observed from the surface of the article comprising the composition of the invention than is observed from the surface of the article of the comparative example.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A method for reducing stringiness during hot plate welding of an article comprising at least one rubber modified thermoplastic resin, which comprises the step of including an effective amount of a polyamide in the composition of the article to be welded;
wherein said resin comprises a discontinuous elastomeric phase dispersed in a rigid thermoplastic phase, and wherein at least a portion of the rigid thermoplastic phase is grafted to the elastomeric phase.

2. The method of claim 1, wherein the polyamide comprises a polyamide-6 or a polyamide-66.

3. The method of claim 1, wherein the polyamide is present in an amount in a range of between about 1 wt. % and about 15 wt. %, based on the total weight of resinous components in the composition.

4. The method of claim 1, wherein the initial elastomeric phase is selected from the group consisting of an elastomeric phase with a particle size distribution in a range of between about 80 nm and about 400 nm; an elastomeric phase with a particle size distribution in a range of between about 400 nm and about 1000 nm; an elastomeric phase with a broad particle size distribution, and mixtures of these elastomeric phases.

5. The method of claim 1, wherein the rubber modified thermoplastic resin comprises acrylonitrile-styrene-acrylate resin, acrylate-modified acrylonitrile-styrene-acrylate resin, methyl methacrylate-modified acrylonitrile-styrene-acrylate resin, acrylonitrile-butadiene-styrene resin; acrylonitrile-(ethylene-propylene-based rubber)-styrene resins; styrene-acrylonitrile grafted polydimethylsiloxane rubber resins; methyl methacrylate-butadiene-styrene resin, methyl methacrylate-acrylonitrile-butadiene-styrene resin; rubber modified acrylic resin; or rubber modified poly(methyl methacylate).

6. The method of claim 5, wherein the composition further comprises at least one of a polystyrene, a syndiotactic polystyrene, a styrene/acrylonitrile copolymer, an alpha-methylstyrene/acrylonitrile copolymer, an alpha-methylstyrene/styrene/acrylonitrile copolymer, a styrene/acrylonitrile/methyl methacrylate copolymer, an alpha-methylstyrene/acrylonitrile/methyl methacrylate copolymer, an alpha-methylstyrene/styrene/acrylonitrile/methyl methacrylate copolymer, a styrene/methyl methacrylate copolymer; a copolymer comprising structural units derived from styrene in combination with at least one carboxylic acid monomer, carboxylic acid anhydride monomer, carboxylic acid amide monomer, epoxy monomer, or oxazoline monomer; a styrene/maleic anhydride copolymer; a styrene/acrylonitrile/maleic anhydride copolymer, a styrene/acrylonitrile/acrylic acid copolymer; styrene/acrylonitrile/acrylamide copolymer; styrene/glycidyl methacrylate copolymer; styrene/acrylonitrile/glycidyl methacrylate copolymer; styrene/isopropenyl oxazoline copolymer; styrene/acrylonitrile/isopropenyl oxazoline copolymer; poly(vinyl chloride); a polycarbonate; a bisphenol A polycarbonate; an acrylic polymer; poly(methyl methacrylate); a polyester; a poly(alkylene terephthalate); a poly(alkylene naphthalate); poly(ethylene terephthalate); poly(butylene terephthalate); poly(trimethylene terephthalate); poly(ethylene naphthalate); poly(butylene naphthalate); poly(cyclohexanedimethanol terephthalate); poly(cyclohexanedimethanol-co-ethylene terephthalate); poly(1,4-cyclohexane-dimethyl-1,4-cyclohexanedicarboxylate); a polyarylate; a polyarylate with structural units derived from resorcinol and a mixture of iso- and terephthalic acids; a polyestercarbonate; a polyestercarbonate with structural units derived from bisphenol A, carbonic acid and a mixture of iso- and terephthalic acids; a polyestercarbonate with structural units derived from resorcinol, carbonic acid and a mixture of iso- and terephthalic acids; a polyestercarbonate with structural units derived from bisphenol A, resorcinol, carbonic acid and a mixture of iso- and terephthalic acids; or mixtures of the foregoing resins.

7. The method of claim 1, wherein the composition comprises at least one of acrylonitrile-styrene-acrylate resin or methyl methacrylate-modified acrylonitrile-styrene-acrylate resin, in combination with at least one resin selected from the group consisting of styrene/acrylonitrile copolymer, alpha-methyl styrene/acrylonitrile copolymer, styrene/acrylonitrile/methyl methacrylate copolymer, and combinations thereof.

8. The method of claim 1, wherein the composition further comprises at least one additive selected from the group consisting of a fluoropolymer, polytetrafluoroethylene, a silicone oil, a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; a plurality of metal flakes; and mixtures thereof.

9. The method of claim 1, further comprising the steps of (i) providing a first formed article comprising the said composition; (ii) contacting a hot plate against the surface of the formed article, thereby melting at least a portion of the surface of said article; (iii) removing the hot plate from said surface; and then (iv) adhering the melted portion to a second article to form a final article.

10. The method of claim 9, wherein the contacted surface of said second article is melted before contact with said first article.

11. A final article made by the method of claim 1.

12. A method for reducing stringiness during hot plate welding of an article comprising at least one rubber modified thermoplastic resin, which comprises the steps of (a) providing a composition comprising acrylonitrile-styrene-acrylate resin, acrylate-modified acrylonitrile-styrene-acrylate resin, methyl methacrylate-modified acrylonitrile-styrene-acrylate resin, acrylonitrile-butadiene-styrene resin; acrylonitrile-(ethylene-propylene-based rubber)-styrene resins; styrene-acrylonitrile grafted polydimethylsiloxane rubber resins; methyl methacrylate-butadiene-styrene resin, methyl methacrylate-acrylonitrile-butadiene-styrene resin; rubber modified acrylic resin; or rubber modified poly(methyl methacylate); (b) adding to the composition either polyamide-6 or polyamide-66 in an amount in a range of between about 1 wt. % and about 15 wt. %, based on the total weight of resinous components in the composition; (c) providing a first formed article comprising the composition from step (b); (d) contacting a hot plate against a surface of the formed article, thereby melting at least a portion of the surface of said article; (e) removing the hot plate from said surface; and then (f) adhering the melted portion to a second article to form a final article.

13. The method of claim 12, wherein the rubber phase is selected from the group consisting of a rubber phase with a particle size distribution in a range of between about 80 nm and about 400 nm; a rubber phase with a particle size distribution in a range of between about 400 nm and about 1000 nm; a rubber phase with a broad particle size distribution, and mixtures of these rubber phases.

14. The method of claim 12, wherein the composition further comprises at least one of a polystyrene, a syndiotactic polystyrene, a styrene/acrylonitrile copolymer, an alpha-methylstyrene/acrylonitrile copolymer, an alpha-methylstyrene/styrene/acrylonitrile copolymer, a styrene/acrylonitrile/methyl methacrylate copolymer, an alpha-methylstyrene/acrylonitrile/methyl methacrylate copolymer, an alpha-methylstyrene/styrene/acrylonitrile/methyl methacrylate copolymer, a styrene/methyl methacrylate copolymer, a copolymer comprising structural units derived from styrene in combination with at least one carboxylic acid monomer, carboxylic acid anhydride monomer, carboxylic acid amide monomer, epoxy monomer, or oxazoline monomer; a styrene/maleic anhydride copolymer; a styrene/acrylonitrile/maleic anhydride copolymer, a styrene/acrylonitrile/acrylic acid copolymer; styrene/acrylonitrile/acrylamide copolymer; styrene/glycidyl methacrylate copolymer; styrene/acrylonitrile/glycidyl methacrylate copolymer; styrene/isopropenyl oxazoline copolymer; styrene/acrylonitrile/isopropenyl oxazoline copolymer; poly(vinyl chloride); a polycarbonate; a bisphenol A polycarbonate; an acrylic polymer; poly(methyl methacrylate); a polyester; a poly(alkylene terephthalate); a poly(alkylene naphthalate); poly(ethylene terephthalate); poly(butylene terephthalate); poly(trimethylene terephthalate); poly(ethylene naphthalate); poly(butylene naphthalate); poly(cyclohexanedimethanol terephthalate); poly(cyclohexanedimethanol-co-ethylene terephthalate); poly(1,4-cyclohexane-dimethyl-1,4-cyclohexanedicarboxylate); a polyarylate; a polyarylate with structural units derived from resorcinol and a mixture of iso- and terephthalic acids; a polyestercarbonate; a polyestercarbonate with structural units derived from bisphenol A, carbonic acid and a mixture of iso- and terephthalic acids; a polyestercarbonate with structural units derived from resorcinol, carbonic acid and a mixture of iso- and terephthalic acids; a polyestercarbonate with structural units derived from bisphenol A, resorcinol, carbonic acid and a mixture of iso- and terephthalic acids; or mixtures of the foregoing resins.

15. The method of claim 12, wherein the composition comprises at least one of acrylonitrile-styrene-acrylate resin or methyl methacrylate-modified acrylonitrile-styrene-acrylate resin, in combination with at least one resin selected from the group consisting of styrene/acrylonitrile copolymer, alpha-methyl styrene/acrylonitrile copolymer, styrene/acrylonitrile/methyl methacrylate copolymer, and combinations thereof.

16. The method of claim 12, wherein the contacted surface of said second article is melted before contact with said first article.

17. The method of claim 12, wherein the resinous composition further comprises at least one additive selected from the group consisting of a fluoropolymer, polytetrafluoroethylene, a silicone oil, a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; a plurality of metal flakes; and mixtures thereof.

18. A final article made by the method of claim 12.
